(19) United States
(12) Patent Application Publication
(10) Pub. No.: US 2023/0093449 A1
(43) Pub. Date: Mar. 23, 2023

(54) ANODE AND BATTERY

(71) Applicant: TOYOTA JIDOSHA KABUSHIKI KAISHA, Toyota-shi (JP)

(72) Inventor: Daisuke HORIKAWA, Kariya-shi (JP)

(73) Assignee: TOYOTA JIDOSHA KABUSHIKI KAISHA, Toyota-shi (JP)

(21) Appl. No.: 17/941,361

(22) Filed: Sep. 9, 2022

(30) Foreign Application Priority Data
Sep. 21, 2021 (JP) 2021-152849

(51) Int. Cl. H01M 4/38; H01M 4/04; H01M 10/0525

(52) U.S. Cl. CPC H01M 4/382; H01M 4/0404; H01M 10/0525; H01M 2004/021

(57) ABSTRACT

A main object of the present disclosure is to provide an anode with excellent capacity durability. The present disclosure achieves the object by providing an anode including an anode current collector, and an anode active material layer arranged on the anode current collector, wherein: the anode active material layer includes a Li composite layer containing a Li composite including a Li element and a dope element; and in the Li composite layer, when C₁ designates a concentration of the dope element in a first surface that is an opposite side of the anode current collector side, and C₂ designates a concentration of the dope element in a second surface that is the anode current collector side, the C₂ is larger than the C₁.

### TECHNICAL FIELD

The present disclosure relates to an anode and a battery.

### BACKGROUND

In recent years, along with a rapid spread of electronic equipment such as a mobile phone, the development of a battery to be used as a power source thereof has been advanced. Also, the development of a battery used for a hybrid electric vehicle (HEV), a plug-in hybrid electric vehicle (PHEV), or a battery electric vehicle (BEV) has been advanced in the automobile industry. Among various batteries, a lithium ion secondary battery is advantageous in its high energy density.

A battery represented by the lithium ion secondary battery usually comprises a cathode, an anode, and an electrolyte layer arranged between the cathode and the anode. The anode includes, for example, an anode current collector, and an anode active material layer (anode layer) arranged on the anode current collector. For example, Patent Literature 1 discloses an anode layer for an all solid secondary battery including a sulfide-based solid electrolyte. Patent Literature 1 discloses that a first anode active material layer includes a lithium metal composite containing a lithium metal and an inorganic anode active material (such as fluoridated lithium). Also, Patent Literature 2 discloses an all solid state battery utilizing the deposition—dissolution reactions of a metal lithium as an anode reaction. Patent Literature 2 discloses that the anode layer includes, as an anode active material, an alloy with β single phase of a metal lithium and a metal magnesium.

### CITATION LIST

### Patent Literature

Patent Literature 1: Japanese Patent Application Laid-Open (JP-A) No. 2021-077640

Patent Literature 2: JP-A No. 2020-184513

### SUMMARY OF DISCLOSURE

### Technical Problem

A battery with little capacity decrease due to charge and discharge has been required. The present disclosure has been made in view of the above circumstances and a main object thereof is to provide an anode with excellent capacity durability.

### Solution to Problem

The present disclosure provides an anode including an anode current collector, and an anode active material layer arranged on the anode current collector, wherein: the anode active material layer includes a Li composite layer containing a Li composite including a Li element and a dope element; and in the Li composite layer, when C₁ designates a concentration of the dope element in a first surface that is an opposite side of the anode current collector side, and C₂ designates a concentration of the dope element in a second surface that is the anode current collector side, the C₂ is larger than the C₁.

According to the present disclosure, the Li composite including a Li element and a dope element is used, and the concentration of the dope element has the relation of C₂>C₁, and thus the anode may have excellent capacity durability.

In the disclosure, in a direction from the second surface toward the first surface, a concentration of the dope element in the Li composite layer may stepwisely or continuously decrease.

In the disclosure, the C₁ may be larger than 0 atm %.

In the disclosure, a rate of the C₂ with respect to the C₁, which is C₂/C₁ may be 1.25 or more and 100 or less.

In the disclosure, the C₁ may be 0 atm %.

In the disclosure, the Li composite layer may contain, as the dope element, at least one kind of Mg, Al, Zn, Ag, Au, Si, Sn, In, Bi, Pd and Rh.

The present disclosure also provides a battery comprising: a cathode including a cathode current collector and a cathode active material layer; an anode including an anode current collector and an anode active material layer; and an electrolyte layer arranged between the cathode active material layer and the anode active material layer, wherein: the anode is the above described anode.

According to the present disclosure, usage of the above described anode allows the battery to have excellent cycle characteristics.

### Advantageous Effects of Disclosure

The anode in the present disclosure exhibits an effect of excellent capacity durability.

### BRIEF DESCRIPTION OF DRAWINGS

FIGS. 1A and 1B are explanatory views explaining the anode in the present disclosure.

FIG. 2 is an explanatory view explaining the Li composite layer in the present disclosure.

FIGS. 3A and 3B are explanatory views explaining the Li composite layer in the present disclosure.

FIGS. 4A and 4B are explanatory views explaining the Li composite layer in the present disclosure.

FIGS. 5A and 5B are explanatory views explaining the Li composite layer in the present disclosure.

FIGS. 6A and 6B are explanatory views explaining the Li composite layer in the present disclosure.

FIG. 7 is a schematic cross-sectional view exemplifying the battery in the present disclosure.

FIG. 8 is the result of a SEM-EDX measurement to the anode obtained in Example 13.

### DESCRIPTION OF EMBODIMENTS

The anode and the battery in the present disclosure will be hereinafter explained in details. In the present description, upon expressing an embodiment of arranging one member with respect to the other member, when it is expressed simply “on”, both of when the other member is directly arranged on the one member so as to contact with each other, and when the other member is arranged above the one member interposing an additional member, can be included unless otherwise described.

### A. Anode

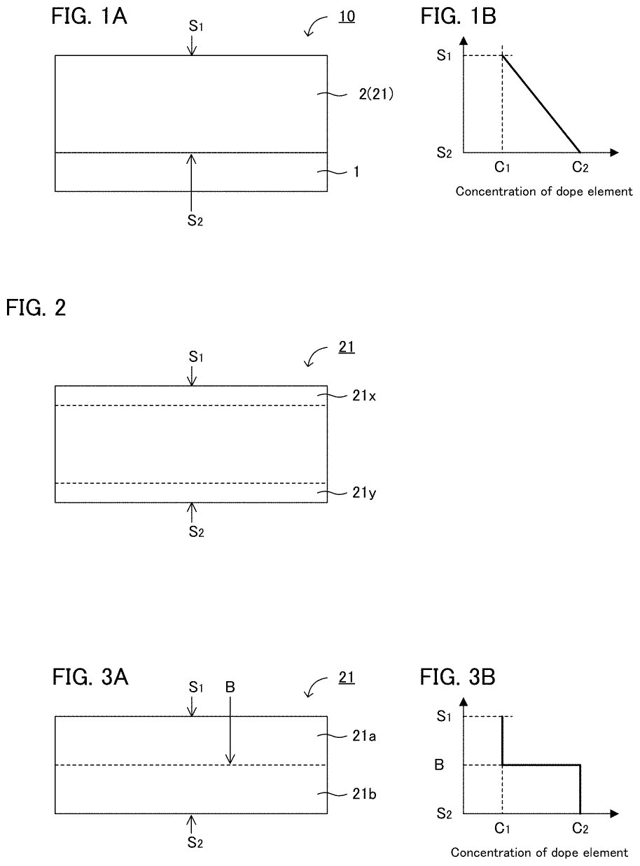

FIG. 1A is a schematic cross-sectional view exemplifying the anode in the present disclosure. Anode 10 illustrated in FIG. 1A comprises anode current collector 1, and anode active material layer 2 arranged on the anode current collector 1. The anode active material layer 2 includes Li composite layer 21 containing a Li composite including a Li element and a dope element. FIG. 1B is a graph exemplifying the concentration distribution of the dope element of FIG. 1A. As shown in FIGS. 1A and 1B, in the Li composite layer 21, C₁ designates a concentration of the dope element in first surface S₁ that is an opposite side of the anode current collector 1 side, and C₂ designates a concentration of the dope element in second surface S₂ that is the anode current collector 1 side. In the present disclosure, the C₂ is larger than the C₁.

According to the present disclosure, the Li composite including a Li element and a dope element is used, and the concentration of the dope element has the relation of C₂>C₁, and thus the anode may have excellent capacity durability. The inventor of the present disclosure had first predicted that concentration distribution of the dope element in the Li composite layer being uniform (such as C₁=C₂) would be preferable from the viewpoint of capacity durability. The reason therefor is that it was predicted that concentration distribution of the dope element being nonuniform would cause slippage or isolation of Li since the interface of compositions with different concentrations (interface in which the crystal structures slightly differ) would be an occurrence origin of a crack due to the volume change along with charge and discharge.

In contrast, surprisingly, improvement of the capacity durability was confirmed when the concentration of the dope element was set as C₂>C₁. The reason therefor is presumably because the stress caused by the volume change of Li along with charge and discharge was relieved when the concentration C₂ of the dope element in the surface of the anode current collector side was set high, and the concentration C₁ of the dope element in the surface of the opposite side to the anode current collector was set low, and thereby the occurrence of the crack was inhibited. Also, as described in Examples later, decrease in battery resistance was confirmed when the concentration of the dope element was set as C₂>C₁. The reason therefor is presumably because the dispersion speed of Li ions improved when the concentration C₂ of the dope element in the surface of the anode current collector side was set high, and the concentration C₁ of the dope element in the surface of the opposite side to the anode current collector side was set low.

### 1. Anode Active Material Layer

The anode active material layer in the present disclosure includes a Li composite layer containing a Li composite including a Li element and a dope element. The dope element is usually an element other than a Li element, and an element capable of forming a solid solution (such as penetrating solid solution or substituent solid solution) or an intermetallic compound with a metal Li. In other words, the Li composite is usually a solid solution including a Li element and a dope element, or an intermetallic compound including a Li element and a dope element. The dope element is typically a metal element, and the Li composite is typically a Li alloy.

Examples of the dope element may include Mg, Al, Zn, Ag, Au, Si, Sn, In, Bi, Pd, and Rh. The Li composite may include just one kind of the dope element, and may include two kinds or more thereof. The Li composite may include just the Li element and the dope element, and may include an additional element (an element not forming the solid solution or the intermetallic compound with the metal Li) in addition to the Li element and the dope element. In the Li composite, the total proportion of the Li element and the dope element is, for example, 75 atm % or more, may be 85 atm % or more, and may be 95 atm % or more.

As shown in FIGS. 1A and 1B, in the Li composite layer 21, C₁ designates a concentration of the dope element in the first surface S₁ that is an opposite side of the anode current collector 1 side, and C₂ designates a concentration of the dope element in the second surface S₂ that is the anode current collector 1 side. The concentration of the dope element may be obtained by measurement with a scanning electron microscope—energy dispersive X-ray spectroscopy (SEM-EDX).

From the viewpoint of improving accuracy, C₁ is preferably calculated from the average concentration of the dope element in the specified region including the first surface S₁. In specific, as shown in FIG. 2, it is preferable to measure the average concentration of the dope element in the specified region 21x including the first surface S₁. For example, when the thickness of the Li composite layer 21 is 4 μm or more, the region 21x is, for example, a region in 2 μm from the first surface S₁. Similarly, from the viewpoint of improving accuracy, C₂ is preferably calculated from the average concentration of the dope element in the specified region including the second surface S₂. In specific, as shown in FIG. 2, it is preferable to measure the average concentration of the dope element in the specified region 21y including the second surface S₂. For example, when the thickness of the Li composite layer 21 is 4 μm or more, the region 21y is, for example, a region in 2 μm from the second surface S₂.

The C₁ may be 0 atm % and may be larger than 0 atm %. In the latter case, the C₁ is, for example, 0.005 atm % or more, may be 0.01 atm % or more, may be 0.1 atm % or more, and may be 1 atm % or more. Meanwhile, the C₁ is, for example, 80 atm % or less and may be 70 atm % or less.

The C₂ is larger than the C₁. The C₂ is, for example, 0.5 atm % or more, may be 1 atm % or more, and may be 5 atm % or more. Meanwhile, the C₂ may be 100 atm %, and may be less than 100 atm %. In the latter case, the C₂ is, for example, 95 atm % or less, may be 90 atm % or less, and may be 85 atm % or less.

When the C₁ is larger than 0 atm %, the rate of the C₂ with respect to the C₁, which is C₂/C₁ is, for example, 1.03 or more, may be 1.05 or more, may be 1.08 or more, and may be 1.25 or more. When the C₂/C₁ is 1.25 or more, the capacity durability would be particularly high. Meanwhile, the C₂/C₁ is, for example, 1000 or less, may be 700 or less, may be 200 or less, and may be 100 or less. When the C₂/C₁ is 100 or less, the capacity durability would be particularly high.

In a direction from the second surface toward the first surface, the concentration of the dope element in the Li composite layer may stepwisely decrease. For example, Li composite layer 21 illustrated in FIG. 3A includes first region 21a including first surface S₁, and second region 21b including second surface S₂, and the first region 21a contacts the second region 21b in boundary B. There is no interface (solid/solid interface) between the first region 21a and the second region 21b, but the both are continuously formed. Also, as shown in FIG. 3B, the concentration of the dope element in the first region 21a is uniform at C₁. Similarly, the concentration of the dope element in the second region 21b is uniform at C₂. In FIGS. 3A and 3B, in a direction from the second surface S₂ toward the first surface S₁, the concentration of the dope element in the Li composite layer 21 stepwisely decreases. Incidentally, in FIGS. 3A and 3B, the concentration of the dope element stepwisely (rapidly) changes at the boundary B, but the concentration of the dope element may continuously change near the boundary B.

In FIGS. 3A and 3B, in the direction from the second surface S₂ toward the first surface S₁, the concentration of the dope element stepwisely decreases in two steps at C₂ and C₁. In the present disclosure, in the direction from the second surface toward the first surface, the concentration of the dope element may stepwisely decrease in three steps or more. For example, in the direction from the second surface toward the first surface, the concentration of the dope element may stepwisely decrease in the order of C₂, C₃ and C₁. In this case, the C₃ satisfies C₂>C₃>C₁.

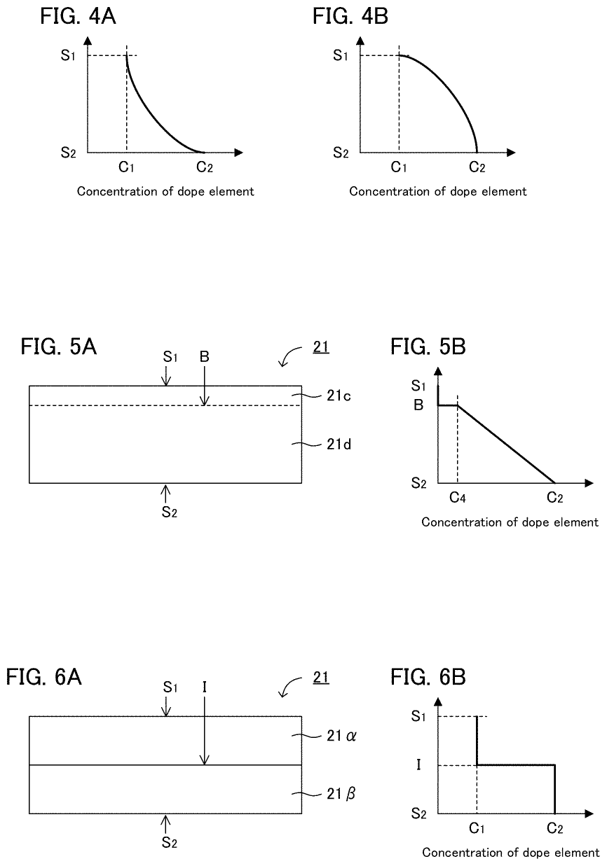

In the direction from the second surface toward the first surface, the concentration of the dope element in the Li composite layer may continuously decrease. For example, as shown in FIG. 1B, in the direction from second surface S₂ toward first surface S₁, the concentration of the dope element may continuously decrease from C₂ to C₁. Also, in FIG. 1B, the concentration of the dope element decreases linearly from C₂ to C₁. In contrast, as shown in FIGS. 4A and 4B, the concentration of the dope element may decrease curvily from C₂ to C₁.

As described above, the C₁ may be 0 atm %. For example, Li composite layer 21 illustrated in FIG. 5A includes third region 21c. The third region 21c includes first surface S₁, and the concentration of the dope element in the third region 21c is 0 atm %. The third region 21c is preferably a layer containing just a Li element. The thickness of the third region 21c is, for example, 100 nm or more, may be 1 μm or more, and may be 5 μm or more. The Li composite layer 21 illustrated in FIG. 5A includes the third region 21c, and fourth region 21d containing a Li composite, and the third region 21c contacts the fourth region 21d in the boundary B. There is no interface (solid/solid interface) between the third region 21c and the fourth region 21d, and the both are continuously formed.

As shown in FIGS. 5A and 5B, C₄ designates the concentration of the dope element in the boundary B. The C₄ is usually larger than 0 atm %. The preferable value range of C₄ is the same as the preferable value range of C₁ described above. Also, preferable range of the rate of the C₂ with respect to the C₄, which is C₂/C₄ is the same as the preferable value range of the C₂/C₁ described above. In a direction from the second surface toward the boundary B, it is preferable that the concentration of the dope element in the Li composite layer stepwisely or continuously decreases. In the direction from the second surface toward the boundary B, the concentration of the dope element may stepwisely decrease in two steps, and may stepwisely decrease in three steps or more. Also, in the direction from the second surface toward the boundary B, when the concentration of the dope element continuously decreases, the concentration of the dope element may linearly or curvily decrease from C₂ to C₄.

The Li composite layer in the present disclosure may be a layered body in which a plurality of parts are layered. Li composite layer 21 illustrate in FIG. 6A includes first part 21α including first surface S₁, and second part 21β including second surface S₂, and the first part 21α contacts the second part 21β in boundary I. Also, as shown in FIG. 6B, the concentration of the dope element in the first part 21α is uniform at C₁. Similarly, the concentration of the dope element in the second part 21β is uniform at C₂. In FIGS. 6A and 6B, in the direction from the second surface S₂ toward the first surface S₁, the concentration of the dope element in the Li composite layer 21 stepwisely decreases. Also, although not particularly illustrated, the Li composite layer may include a first part including a first surface, a second part including a second surface, and one or two or more of a third part arranged between the first part and the second part.

Examples of the shape of the Li composite layer may include a foil shape (film shape). It is preferable that the Li composite layer is a layer containing a Li composite in a foil shape (film shape). The Li composite layer may be a vapor deposition layer of the Li composite. Also, the Li composite layer is usually not a layer containing the Li composite in a granular shape.

The thickness of the Li composite layer is not particularly limited, and for example, it is 1 μm or more, may be 5 μm or more, and may be 10 μm or more. Meanwhile, the thickness of the Li composite layer is, for example, 1000 μm or less, may be 500 μm or less, and may be 300 μm or less. There are no particular limitations on the method for forming the Li composite layer, and examples thereof may include a PVD method such as a vacuum vapor deposition method, a spattering method and an ion plating method.

The anode active material layer in the present disclosure may include just the Li composite layer, and may further include an additional layer contributing to charge and discharge capacity, in addition to the Li composite layer.

### 2. Anode Current Collector

The anode current collector in the present disclosure collects currents of the anode active material layer. Examples of the material for the anode current collector may include SUS, copper, nickel, and carbon. Examples of the shape of the anode current collector may include a foil shape and a mesh shape. The anode current collector is, for example, arranged in the opposite side to the electrolyte layer on the basis of the anode active material layer.

### 3. Anode

The anode in the present disclosure includes the above described anode active material layer and anode current collector. The anode is preferably used in a battery.

### B. Battery

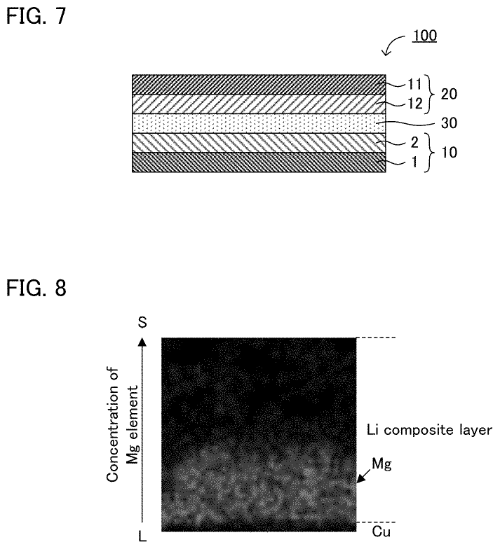

FIG. 7 is a schematic cross-sectional view exemplifying the battery in the present disclosure. Battery 100 illustrated in FIG. 7 includes cathode 20 including cathode current collector 11 and cathode active material layer 12, anode 10 including anode current collector 1 and anode active material layer 2, and electrolyte layer 30 arranged between the cathode active material layer 12 and the anode active material layer 2. The anode 10 is the anode described in “A. Anode” above.

According to the present disclosure, usage of the above described anode allows the battery to have excellent cycle characteristics.

### 1. Anode

The anode in the present disclosure is in the same contents as those described in “A. Anode” above; thus, the descriptions herein are omitted. The Li composite layer in the anode may contact the electrolyte layer. Also, a Li deposition layer may be arranged between the Li composite layer in the anode and the electrolyte layer. The Li deposition layer is a layer of Li deposited due to charge.

### 2. Cathode

The cathode in the present disclosure includes a cathode current collector and a cathode active material layer. The cathode active material layer contains at least a cathode active material. Examples of the cathode active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li₄Ti₅O₁₂, and Li(Ni_{0.5}Mn_{1.5})O₄; and an olivine type active material such as LiFePO₄, LiMnPO₄, LiNiPO₄, and LiCoPO₄.

The cathode active material layer may further contain at least one of an electrolyte, a conductive material, and a binder. The details of the electrolyte will be described in “3. Electrolyte layer” later. Examples of the conductive material may include a carbon material. Examples of the carbon material may include a particulate carbon material such as acetylene black (AB) and Ketjen black (KB), and a fiber carbon material such as carbon fiber, carbon nanotube (CNT), and carbon nanofiber (CNF). Examples of the binder may include a fluorine-containing binder such as polyvinylidene fluoride (PVDF) and polytetra fluoroethylene (PTFE). Also, the thickness of the cathode active material layer is, for example, 0.1 μm or more and 1000 μm or less.

The cathode current collector collects currents of the cathode active material layer. Examples of the material for the cathode current collector may include SUS, aluminum, nickel, iron, titanium and carbon. Examples of the shape of the cathode current collector may include a foil shape and a mesh shape. The cathode current collector is, for example, arranged in the opposite side to the electrolyte layer on the basis of the cathode active material layer.

### 3. Electrolyte Layer

The electrolyte layer in the present disclosure contains at least an electrolyte. Examples of the electrolyte may include a solution electrolyte (liquid electrolyte), a gel electrolyte, and a solid electrolyte. Among those, the battery in the present disclosure is preferably a liquid battery in which the electrolyte layer contains a solution electrolyte (liquid electrolyte). As described in Examples later, it is effective to reduce battery resistance.

The liquid electrolyte contains, for example, a lithium salt and a solvent. Examples of the lithium salt may include an inorganic lithium salt such as LiPF₆, LiBF₄, LiClO₄ and LiAsF₆; and an organic lithium salt such as LiCF₃SO₃, LiN (SO₂CF₃)₂, LiN (SO₂C₂F₅)₂, and LiC (SO₂CF₃)₃. Examples of the solvent may include ethylene carbonate (EC), propylene carbonate (PC), butylene carbonate (BC), dimethyl carbonate (DMC), diethyl carbonate (DEC), and ethyl methyl carbonate (EMC).

The gel electrolyte is usually obtained by adding a polymer to a liquid electrolyte. Examples of the polymer may include a polyethylene oxide, and a polypropylene oxide. Examples of the solid electrolyte may include an organic solid electrolyte such as a polymer electrolyte; and an inorganic solid electrolyte such as a sulfide solid electrolyte and an oxide solid electrolyte. Also, the thickness of the electrolyte layer is, for example, 0.1 μm or more and 1000 μm or less. The electrolyte layer may include a separator.

### 4. Battery

The battery in the present disclosure is typically a lithium ion secondary battery. Examples of the application of the battery may include a power source for vehicles such as hybrid electric vehicles (HEV), plug-in hybrid electric vehicles (PHEV), battery electric vehicles (BEV), gasoline-fueled automobiles and diesel powered automobiles. Also, the battery in the present disclosure may be used as a power source for moving bodies other than vehicles (such as rail road transportation, vessel and airplane), and may be used as a power source for electronic products such as information processing equipment.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### Production of Anode

By a vacuum vapor deposition method, a Li composite layer containing a Li element and a Mg element (dope element) was formed on an anode current collector (Cu foil). In specific, a melting pot with a Li metal arranged therein, and a melting pot with a Mg metal arranged therein were prepared, and an electron beam heating was performed to these melting pots. By the electron beam heating, Li and Mg were volatilized in a vacuum vapor deposition device, deposited on the surface of the Cu foil, and thereby the Li composite layer (thickness: 40 μm) was formed. On this occasion, the conditions for the vapor deposition were adjusted so as to obtain the desired Li composite layer (Li composite layer with concentration C₂ of the Mg element in the second surface being 30 atm % and concentration C₁ of the Mg element in the first surface being 20 atm %). In specific, the concentration of the Li element and the concentration of the Mg element were adjusted by controlling the temperature of the melting pots (in other words, the volatilizing speed of the elements). In this manner, an anode including the anode current collector and the Li composite layer was obtained.

### Production of Cathode

A cathode active material (LiNi_{1/3}Co_{1/3}Mn_{1/3}O₂), a conductive material (acetylene black), a binder (polyvinylidene fluoride) and a dispersing agent were weighed so as to be the cathode active material:the conductive material:the binder:the dispersing agent=80:8:2:0.2 in the weight ratio. These materials were mixed together with N-methyl pyrrolidone to obtain cathode slurry. The obtained cathode slurry was pasted on a cathode current collector (Al foil) and dried to obtain a cathode.

### Production of Battery

As a liquid electrolyte, a solution was prepared by dissolving a supporting electrolyte (LiPF₆) in a non-aqueous solvent (mixture solvent of EC and DMC mixed in the same volume) so that the concentration became 1 M. Also, as a separator, a porous film having a three-layer structure of polypropylene (PP), polyethylene (PE) and polypropylene (PP) was prepared. These members and the above described anode and cathode were used to produce a winding type battery.

### Comparative Example 1

An anode was produced in the same manner as in Example 1 except that the Mg metal was not used. A battery was produced in the same manner as in Example 1 except that the obtained anode was used.

### Comparative Example 2

An anode was produced in the same manner as in Example 1 except that the conditions for the vapor deposition were adjusted so as to obtain a Li composite layer with the concentration C₂ of the Mg element in the second surface being 20 atm % and the concentration C₁ of the Mg element in the first surface being 30 atm %. A battery was produced in the same manner as in Example 1 except that the obtained anode was used.

### Evaluation

### Capacity Durability

The capacity durability after 200 cycles was measured using the batteries obtained in Example 1 and Comparative Examples 1 to 2. The charge and discharge conditions were constant current charge and discharge, the current rate of 1 C, the voltage range of 3.3 V to 4.2 V, and environment temperature of 60° C. The rate of the discharge capacity of the 200th cycle with respect to the discharge capacity of the 1st cycle was determined as the capacity durability. The results are shown in Table 1.

### Battery Resistance

Battery resistance measurement was conducted to the batteries obtained in Example 1 and Comparative Examples 1 to 2. In specific, the open circuit voltage (OCV) of the battery was respectively adjusted to 3.70 V, and then the battery was discharged in the conditions of environment temperature being −5° C., the current rate being 5 C and the discharge time being 8 seconds. The voltage drop AV due to this discharge was respectively obtained and the battery resistance was calculated by the below formula:

Battery resistance=ΔV/(Current value at 5 C).

The results are shown in Table 1. Incidentally, the values of the battery resistance in Table 1 are the relative values when the battery resistance of Comparative Example 1 is determined as 1.00.

TABLE 1

| | | Concentration | | | | Battery |
|---|---|---|---|---|---|---|
| | | of dope | | | Capacity | resistance |
| | Dope | element [atm %] | | | durability | (relative |
| | element | C₁ | C₂ | C₂/C₁ | (%) | value) |
| Comp. Ex. 1 | None | 0 | 0 | — | 50 | 1.00 |
| Comp. Ex. 2 | Mg | 30 | 20 | 0.67 | 62 | 0.95 |
| Ex. 1 | Mg | 20 | 30 | 1.50 | 81 | 0.71 |

As shown in Table 1, the capacity durability of Example 1 was higher than that of Comparative Examples 1 and 2. This is presumably because the stress caused by the volume change of Li along with charge and discharge was relieved since the Li composite layer contains the dope element in addition to the Li element, and further, the concentration of the dope element had the relation of C₂>C₁, and thereby the generation of a crack was inhibited. Also, the battery resistance of Example 1 was lower than that of Comparative Examples 1 and 2. This is presumably because the Li ions smoothly conducted (Li carrier concentration improved) via the dope element since the Li composite layer contains the dope element in addition to the Li element, and further, the concentration of the dope element had the relation of C₂>C₁.

### Examples 2 to 13

An anode was produced in the same manner as in Example 1 except that the C₁ and the C₂ were changed to the values shown in Table 2. A battery was respectively produced in the same manner as in Example 1 except that the obtained anode was used.

### Evaluation

The capacity durability and the battery resistance were obtained using the batteries obtained in Examples 2 to 13 in the same manners as above. The results are shown in Table 2. Incidentally, the values of the battery resistance in Table 2 are the relative values when the battery resistance of Comparative Example 1 is determined as 1.00.

TABLE 2

| | | Concentration | | | | Battery |
|---|---|---|---|---|---|---|
| | | of dope | | | Capacity | resistance |
| | Dope | element [atm %] | | | durability | (relative |
| | element | C₁ | C₂ | C₂/C₁ | (%) | value) |
| Ex. 2 | Mg | 65 | 70 | 1.08 | 72 | 0.81 |
| Ex. 3 | Mg | 0.9 | 1 | 1.11 | 75 | 0.82 |
| Ex. 4 | Mg | 0.8 | 1 | 1.25 | 82 | 0.71 |
| Ex. 5 | Mg | 56 | 70 | 1.25 | 81 | 0.72 |
| Ex. 6 | Mg | 5 | 60 | 12.0 | 84 | 0.75 |
| Ex. 7 | Mg | 1 | 30 | 30.0 | 81 | 0.70 |
| Ex. 8 | Mg | 1 | 50 | 50.0 | 83 | 0.72 |
| Ex. 9 | Mg | 1 | 70 | 70.0 | 85 | 0.74 |
| Ex. 10 | Mg | 0.01 | 1 | 100 | 82 | 0.74 |
| Ex. 11 | Mg | 0.7 | 70 | 100 | 80 | 0.73 |
| Ex. 12 | Mg | 0.005 | 1 | 200 | 72 | 0.81 |
| Ex. 13 | Mg | 0.1 | 70 | 700 | 74 | 0.82 |

As shown in Table 2, the capacity durability and the battery resistance of Examples 2 to 13 were respectively well. In particular, high capacity durability of 80% or more was obtained in Examples 4 to 11. Likewise, the battery resistance of Examples 4 to 11 was respectively particularly low. Also, the cross-section of the anode obtained in Example 13 was observed by SEM-EDX. The result is shown in FIG. 8. As shown in FIG. 8, in the Li composite layer, it was confirmed that the concentration of the dope element had the relation of C₂>C₁.

### Examples 14 to 23

An anode was produced in the same manner as in Example 1 except that the dope element was respectively changed to the elements shown in Table 3. A battery was respectively produced in the same manner as in Example 1 except that the obtained anode was used.

### Evaluation

The capacity durability and the battery resistance were obtained using the batteries obtained in Examples 14 to 23 in the same manners as above. The results are shown in Table 3. Incidentally, the values of the battery resistance in Table 3 are the relative values when the battery resistance of Comparative Example 1 is determined as 1.00.

TABLE 3

| | | Concentration | | | | Battery |
|---|---|---|---|---|---|---|
| | | of dope | | | Capacity | resistance |
| | Dope | element [atm %] | | | durability | (relative |
| | element | C₁ | C₂ | C₂/C₁ | (%) | value) |
| Ex. 1 | Mg | 20 | 30 | 1.50 | 81 | 0.71 |
| Ex. 14 | Al | 20 | 30 | 1.50 | 82 | 0.75 |
| Ex. 15 | Zn | 20 | 30 | 1.50 | 81 | 0.73 |
| Ex. 16 | Ag | 20 | 30 | 1.50 | 83 | 0.72 |
| Ex. 17 | Au | 20 | 30 | 1.50 | 83 | 0.72 |
| Ex. 18 | Si | 20 | 30 | 1.50 | 82 | 0.73 |
| Ex. 19 | Sn | 20 | 30 | 1.50 | 80 | 0.71 |
| Ex. 20 | In | 20 | 30 | 1.50 | 80 | 0.72 |
| Ex. 21 | Bi | 20 | 30 | 1.50 | 82 | 0.74 |
| Ex. 22 | Pd | 20 | 30 | 1.50 | 80 | 0.76 |
| Ex. 23 | Rh | 20 | 30 | 1.50 | 79 | 0.74 |

As shown in Table 3, the capacity durability and the battery resistance of Examples 14 to 23 were respectively well similarly to those of Example 1. In other words, it was confirmed that the similar effects were obtained when elements other than the Mg element was used as the dope element.

### Example 24

An anode was produced in the same manner as in Example 1 except that the C₁ and the C₂ were changed to the values shown in Table 4. A battery was produced in the same manner as in Example 1 except that the obtained anode was used.

### Evaluation

The capacity durability and the battery resistance were obtained by using the battery obtained in Example 24 in the same manners as above. The results are shown in Table 4. Incidentally, the value of the battery resistance in Table 4 is the relative value when the battery resistance of Comparative Example 1 is determined as 1.00.

TABLE 4

| | | Concentration | | | | Battery |
|---|---|---|---|---|---|---|
| | | of dope | | | Capacity | resistance |
| | Dope | element [atm %] | | | durability | (relative |
| | element | C₁ | C₂ | C₂/C₁ | (%) | value) |
| Ex. 24 | Mg | 0 | 30 | — | 70 | 0.84 |

As shown in Table 4, the capacity durability and the battery resistance of Example 24 were well similarly to those of Example 1. In other words, it was confirmed that the similar effects were obtained when C₁ was 0 atm %.

### REFERENCE SINGS LIST

1 anode current collector

2 anode active material layer

10 anode

11 cathode current collector

12 cathode active material layer

20 cathode

21 Li composite layer

30 electrolyte layer

100 battery

What is claimed is:

1. An anode comprising an anode current collector, and an anode active material layer arranged on the anode current collector, wherein:
the anode active material layer includes a Li composite layer containing a Li composite including a Li element and a dope element; and
in the Li composite layer, when C₁ designates a concentration of the dope element in a first surface that is an opposite side of the anode current collector side, and C₂ designates a concentration of the dope element in a second surface that is the anode current collector side, the C₂ is larger than the C₁.

2. The anode according to claim 1, wherein in a direction from the second surface toward the first surface, a concentration of the dope element in the Li composite layer stepwisely or continuously decreases.

3. The anode according to claim 1, wherein the C₁ is larger than 0 atm %.

4. The anode according to claim 3, wherein a rate of the C₂ with respect to the C₁, which is C₂/C₁ is 1.25 or more and 100 or less.

5. The anode according to claim 1, wherein the C₁ is 0 atm %.

6. The anode according to claim 1, wherein the Li composite layer contains, as the dope element, at least one kind of Mg, Al, Zn, Ag, Au, Si, Sn, In, Bi, Pd and Rh.

7. A battery comprising:
a cathode including a cathode current collector and a cathode active material layer;
an anode including an anode current collector and an anode active material layer; and
an electrolyte layer arranged between the cathode active material layer and the anode active material layer, wherein:
the anode is the anode according to claim 1.
